(19) United States
(12) Patent Application Publication
(10) Pub. No.: US 2026/0239247 A1
(43) Pub. Date: Aug. 13, 2026

(54) WIRELESS COMMUNICATION METHOD AND TERMINAL DEVICE

(71) Applicant: GUANGDONG OPPO MOBILE TELECOMMUNICATIONS CORP., LTD., Dongguan, Guangdong (CN)

(72) Inventors: Haitao LI, Dongguan, Guangdong (CN); Yi HU, Dongguan, Guangdong (CN); Xinlei YU, Dongguan, Guangdong (CN)

(21) Appl. No.: 19/154,974

(22) PCT Filed: Aug. 22, 2022
(86) PCT No.: PCT/CN2022/113967

§ 371 Date: Aug. 8, 2025

(51) Int. Cl. H04W 56/00; H04B 17/318; H04W 24/10; H04W 64/00

(52) U.S. Cl. CPC H04W 56/0045; H04B 17/328; H04W 24/10; H04W 64/00

(57) ABSTRACT

Embodiments of the disclosure provide a wireless communication method and, a terminal device. The wireless communication method includes the following. A terminal device receives first information, where the first information is used to configure or indicate the terminal device to report timing advance (TA) values at M moments, where M is a positive integer and M≥2.

### CROSS REFERENCE TO RELATED APPLICATION(S)

This application is U.S. National Stage entry of International Application No. PCT/CN2022/113967, filed Aug. 22, 2022, which is incorporated herein by reference in its entirety.

### TECHNICAL FIELD

Embodiments of the disclosure relate to the field of communications, and in particular, to a wireless communication method and a terminal device.

### BACKGROUND

In new radio (NR) systems, a positioning method combining uplink (UL) positioning and downlink (DL) positioning has a high positioning accuracy. A terminal device and multiple base stations (or transmission reception points (TRP)) can transmit reference signals to each other, and the location of the terminal device can be determined based on a time difference between reception of the signal and transmission of the signal at the terminal device, a time difference between reception of the signal and transmission of the signal at the base station, an UL angle of arrival (UL-AoA), and other data. However, in non-terrestrial network (NTN) scenarios, at the same moment, the terminal device usually communicates with one satellite. In this case, how to position the terminal is a problem to be solved.

### SUMMARY

In a first aspect, a wireless communication method is provided. The method includes the following. A terminal device receives first information, where the first information is used to configure or indicate the terminal device to report TA values at M moments, where M is a positive integer and M≥2.

In a second aspect, a wireless communication method is provided. The method includes the following. A core network device transmits first information, where the first information is used to configure or indicate a terminal device to report TA values at M moments, where M is a positive integer and M≥2.

In a third aspect, a terminal device is provided. The terminal device includes a processor and a memory. The memory is configured to store computer programs. The processor is configured to invoke and execute the computer programs stored in the memory, to cause the terminal device to perform the method in the first aspect.

### BRIEF DESCRIPTION OF THE DRAWINGS

FIG. 1 is a schematic diagram of a communication system architecture applied in embodiments of the disclosure.

FIG. 2 is a schematic diagram of a satellite network architecture of transparent payload provided in the disclosure.

FIG. 3 is a schematic diagram of a satellite network architecture of regenerative payload provided in the disclosure.

FIG. 4 is a schematic diagram of a 5G positioning architecture provided in the disclosure.

FIG. 5 is a schematic interactive flowchart of a wireless communication method provided according to embodiments of the disclosure.

FIG. 6 is a schematic flowchart of configuring a TA by a core network device and reporting a TA value by a terminal device provided in embodiments of the disclosure.

FIG. 7 is a schematic interactive flowchart of another wireless communication method provided according to embodiments of the disclosure.

FIG. 8 is a schematic flowchart of configuring a TA by a core network device and reporting a TA value by an access network device provided in embodiments of the disclosure.

FIG. 9 is a schematic block diagram of a terminal device provided according to embodiments of the disclosure.

FIG. 10 is a schematic block diagram of a core network device provided according to embodiments of the disclosure.

FIG. 11 is a schematic block diagram of an access network device provided according to embodiments of the disclosure.

FIG. 12 is a schematic block diagram of another core network device provided according to embodiments of the disclosure.

FIG. 13 is a schematic block diagram of a communication device provided according to embodiments of the disclosure.

FIG. 14 is a schematic block diagram of an apparatus provided according to embodiments of the disclosure.

FIG. 15 is a schematic block diagram of a communication system provided according to embodiments of the disclosure.

### DETAILED DESCRIPTION

The following will describe technical solutions of embodiments of the disclosure with reference to the accompanying drawings of embodiments of the disclosure. Apparently, embodiments described herein are merely some embodiments, rather than all embodiments, of the disclosure. For the embodiments described herein, all other embodiments obtained by those of ordinary skill in the art without creative effort shall fall within the protection scope of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), an internet of things (IoT), a wireless fidelity (Wi-Fi), a 5th-generation (5G) system, a 6th-generation (6G) system, or other communication systems.

Generally speaking, a conventional communication system generally supports a limited number of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, sidelink (SL) communication, vehicle to everything (V2X) communication, etc. Embodiments of the disclosure can also be applied to these communication systems.

In some embodiments, a communication system of embodiments of the disclosure may be applied to a carrier aggregation (CA) scenario, a dual connectivity (DC) scenario, a standalone (SA) network deployment scenario, or a non-standalone (NSA) network deployment scenario.

In some embodiments, the communication system of embodiments of the disclosure may be applied to an unlicensed spectrum or a licensed spectrum, where the unlicensed spectrum may also be referred to as a shared spectrum, and the licensed spectrum may also be referred to as a non-shared spectrum.

In some embodiments, the communication system in embodiments of the disclosure can be applied to an FR1 frequency band (corresponding to a frequency band range of 410 MHz to 7.125 GHZ), and can also be applied to an FR 2 frequency band (corresponding to a frequency band range of 24.25 GHz to 52.6 GHz), and can also be applied to a new frequency band such as a high-frequency frequency band corresponding to a frequency band range of 52.6 GHz to 71 GHz or corresponding to a frequency band range of 71 GHz to 114.25 GHz.

Embodiments of the disclosure have been described in connection with the network device and the terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device.

The terminal device may be a station (ST) in a WLAN, a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, and a next-generation communication system, for example, a terminal device in an NR network, a terminal device in a future evolved public land mobile network (PLMN), etc.

In embodiments of the disclosure, the terminal device may be deployed on land, for example, deployed indoors or outdoors, and may be handheld, wearable, or vehicle-mounted. The terminal device may also be deployed on water, for example, on a ship, etc. The terminal device may also be deployed in the air, for example, on an airplane, an air balloon, a satellite, etc.

In embodiments of the disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, an in-vehicle communication device, a wireless communication chip/application specific integrated circuit (ASIC)/system on chip (SoC), etc.

By way of explanation rather than limitation, according to embodiments of the disclosure, the terminal device may also be a wearable device. The wearable device may also be called a wearable smart device, which is a generic term of wearable devices obtained through intelligentization designing and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in the WLAN, a base transceiver station (BTS) in the GSM or CDMA, may also be a Node B (NB) in WCDMA, and may further be an evolutional Node B (eNB or eNodeB) or a next generation evolutional Node B (ng-eNB) in LTE, or a relay station or AP, or an in-vehicle device, a wearable device, a network device or a g-Node B (gNB) or a transmission reception point (TRP) in the NR network, a network device in the future evolved PLMN, a network device in a NTN, etc.

By way of example rather than limitation, in embodiments of the disclosure, the network device may be of mobility. For example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station located on land, water, etc.

In embodiments of the disclosure, the network device can provide services for a cell, and the terminal device communicates with the network device through a transmission resource (for example, a frequency-domain resource or a spectrum resource) for the cell. The cell may be a cell corresponding to the network device (for example, a base station). The cell may correspond to a macro base station, and may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

Exemplarily, as illustrated in FIG. 1, a communication system 100 may include a network device 110. The network device 110 may be a device that can communicate with a terminal device 120 (or referred to as a communication terminal or a terminal). The network device 110 can provide a communication coverage for a specific geographical area and communicate with terminal devices in the coverage area.

FIG. 1 exemplarily illustrates one network device and two terminal devices. In some embodiments, the communication system 100 may include multiple network devices, and there may be other numbers of terminal devices in a coverage area of each of the network devices, which is not limited herein.

In some embodiments, the communication system 100 may further include other network entities such as a network controller, a mobility management entity, or the like, which is not limited herein.

It should be understood that, in embodiments of the disclosure, a device having a communication function in a network/system may be referred to as a communication device. Taking the communication system 100 illustrated in FIG. 1 For example, the communication device may include the network device 110 and the terminal device 120 having a communication function, and the network device 110 and the terminal device 120 may be the specific devices described above, which will not be repeated herein. The communication device may also include other devices in the communication system 100, such as a network controller, a mobility management entity, and other network entities, which is not limited herein.

It should be understood that, the terms “system” and “network” herein are usually interchangeable. The term “and/or” herein describes only an association relationship for describing associated objects and represents that three relationships may exist. For example, A and/or B may represent the following three cases: only A exists, both A and B exist, and only B exists. In addition, the character “/” herein generally indicates an “or” relationship between the associated objects.

It should be understood that, the disclosure relates to a first communication device and a second communication device. The first communication device may be a terminal device, such as a mobile phone, a machine facility, a customer premise equipment (CPE), an industrial device, a vehicle, etc. The second communication device may be a peer communication device of the first communication device, such as a network device, a mobile phone, an industrial device, a vehicle, etc. In embodiments of the disclosure, the first communication device may be a terminal device, and the second communication device may be a network device (i.e., UL communication or DL communication). Alternatively, the first communication device may be a first terminal, and the second communication device may be a second terminal (i.e., SL communication).

The terms used in embodiment part of the disclosure are only used to illustrate specific embodiments of the disclosure, but not intended to limit the disclosure. The terms “first”, “second”, “third”, “fourth”, and the like in the specification, claims, and drawings of the disclosure are used to distinguish different objects, but not to describe a specific order. In addition, the terms “including”, “comprising”, “having”, and any variations thereof are intended to cover non-exclusive inclusions.

It should be understood that, the “indication” mentioned in embodiments of the disclosure may be a direct indication or an indirect indication, or indicate an association. For example, if A indicates B, it can mean that A directly indicates B, for example, B can be obtained through A, or mean that A indicates B indirectly, for example, A indicates C, and B can be obtained through C, or it can also mean that there is an association between A and B.

In the description of embodiments of the disclosure, the term “corresponding” can mean that there is a direct or indirect correspondence between two elements, or that there is an association between two elements, or that there is a relationship of “indicating” and “being indicated”, “configuring” and “being configured”, and the like.

In embodiments of the disclosure, the “predefined” or “preconfigured” can be implemented by pre-saving a corresponding code or table in a device (for example, including the terminal device and the network device) or in other manners that can be used for indicating related information, and the disclosure is not limited in this regard. For example, the “predefined” may mean defined in a protocol.

In embodiments of the disclosure, the “protocol” may refer to a communication standard protocol, which may be, for example, an evolution of an existing LTE protocol, NR protocol, Wi-Fi protocol, or another protocol related thereto associated with communication systems. The type of the protocol is not limited in the disclosure.

For better understanding of technical solutions of embodiments of the disclosure, the technical solutions of the disclosure will be described in detail below in connection with embodiments. The following related art as an optional scheme can be arbitrarily combined with the technical solutions of embodiments of the disclosure, which shall all belong to the protection scope of embodiments of the disclosure. Embodiments of the disclosure include at least some of the following.

At present, along with pursuit of people for rate, delay, high-speed mobility, and efficiency, and diversification and complication of services in the future life, the 5G communication network is introduced. 5G is mainly applied to enhanced mobile broadband (eMBB), ultra-reliable low-latency communication (URLLC), and massive machine type communication (mMTC).

eMBB is still aimed at obtaining multimedia content, services, and data for users and grows rapidly in demand. On the other hand, because eMBB may be deployed in different scenarios, such as indoor, urban, rural areas, etc., its capabilities and requirements vary widely. Therefore, analysis of eMBB should depend on specific deployment scenarios. Typical applications of URLLC may include: industrial automation, power automation, telemedicine operations, and traffic safety assurance. mMTC may be typically characterized by: high connection density, small amount of data, delay-insensitive services, low cost of modules, and long service life.

NR may be deployed independently. In 5G network environment, for reduction of air interface signaling and fast recovery of wireless connections and data services, a new radio resource control (RRC) state, i.e., an RRC_INACTIVE state is introduced. The RRC_INACTIVE state is different from an RRC_IDLE state and an RRC_ACTIVE state.

RRC_IDLE: Mobility is based on cell selection/reselection by the terminal, paging is initiated by a core network (CN), a paging area is configured by the CN, and there is no terminal access stratum (AS) context on the base station side, and there is no RRC connection.

RRC_CONNECTED: The RRC connection exists, the terminal AS context exits in the base station and the terminal, the network side is aware of a location of the terminal at a specific cell level, the mobility is controlled on the network side, and unicast data can be transmitted between the terminal and the base station.

RRC_INACTIVE: The mobility is based on cell reselection by the terminal, there is a connection between the CN and the NR (CN-NR), the terminal AS context exists in a base station, the paging is triggered by a radio access network (RAN), an RAN-based paging area is managed by the RAN, and the network side is aware of an RAN paging area level-based location of the terminal.

For better understanding of embodiments of the disclosure, the NTN related to the disclosure is described.

The NTN generally provides communication services to terrestrial users through satellite communication. Compared with terrestrial cellular network communication, the satellite communication has many unique advantages. First, the satellite communication is not constrained by areas of the users. For example, terrestrial communication is not able to cover sparsely populated areas as well as areas where communication devices cannot be set up, such as oceans, mountains, and deserts. In contrast, for the satellite communication, one satellite can cover a large area, and the satellite can orbit the earth, therefore, in theory, every corner on the earth can be covered for satellite communication. Second, the satellite communication has greater social value. Remote mountainous areas, poor and backward countries or regions can be covered for satellite communication at a low cost, so that people in these areas can enjoy advanced voice communication and mobile internet technologies, thereby narrowing a digital gap with developed areas and promoting the development of these areas. Third, a satellite has a long communication distance, and a communication cost thereof does not increase greatly with the increase of the communication distance. Finally, the satellite communication has high stability and is not constrained by natural disasters.

Communication satellites are classified into low-earth orbit (LEO) satellites, medium-earth orbit (MEO) satellites, geostationary earth orbit (GEO) satellites, high elliptical orbit (HEO) satellites, and the like according to different orbital altitudes.

For the LEO satellite, the orbital altitude thereof is in the range of 500 km to 1500 km, a corresponding orbital period is about 1.5 hours to 2 hours, and signal propagation delay of single-hop communication between users is generally less than 20 ms. A satellite has a maximum visibility time of 20 minutes, a short signal propagation distance, and a less link loss is small, and does not have high transmission power requirements for a user terminal.

For the GEO satellite, the orbital altitude thereof is 35786 km, a rotation period around the earth thereof is 24 hours, and signal propagation delay of single-hop communication between users is generally 250 ms.

In order to ensure the coverage of the satellite and increase the system capacity of the entire satellite communication system, the satellite uses multi-beams to cover the ground. One satellite can provide dozens of or even hundreds of beams for ground coverage, and one beam can cover a ground area with a diameter of tens to hundreds of kilometers.

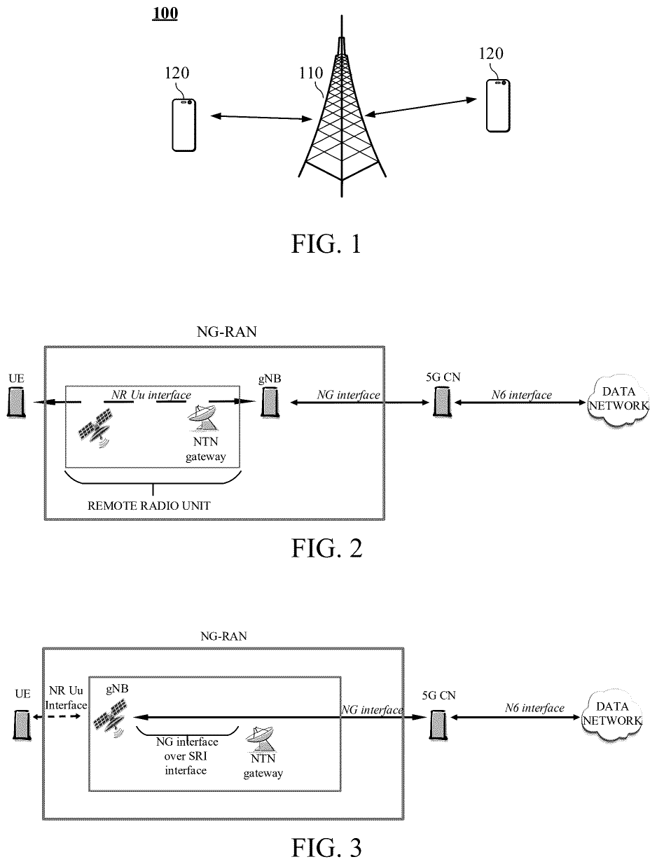

In some embodiments, there are two types of satellites, i.e., transparent payload satellites and regenerative payload satellites. A satellite network architecture of transparent payload can be as illustrated in FIG. 2. A satellite network architecture of regenerative payload can be as illustrated in FIG. 3. A feeder link refers to a radio link between the satellite and the NTN gateway (usually located on the ground). A service link refers to a radio link between the terminal device and the satellite.

For better understanding of embodiments of the disclosure, a 5G positioning architecture related to the disclosure is described.

In the 5G mobile communication system, there are three main network elements in the positioning architecture, i.e., a location service (LCS) client, a LCS server, and a LCS target. The LCS server is an entity that handles positioning of the LCS target and is responsible for providing auxiliary information and performing location calculation. The LCS target generally refers to a terminal (UE). The UE can perform measurement when necessary and collect some data on location information. The LCS client refers to an entity that interacts with the LCS server to obtain the location of the LCS target. The LCS client transmits to the LCS server a request to obtain location data, and the LCS server processes the request and transmits a positioning result to the LCS client.

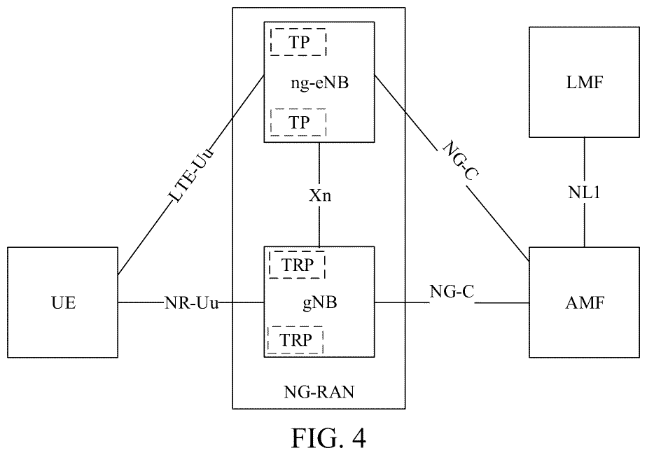

The 5G positioning architecture can be as illustrated in FIG. 4. A UE can be connected to a ng-eNB through an LTE-Uu interface. The UE can be connected to a gNB through an NR-Uu interface. The ng-eNB and the gNB can be connected through a Xn interface. The ng-eNB and the gNB belong to a next generation radio access network (NG-RAN). The ng-eNB can include one or more transmission points (TP). The gNB can include one or more transmission reception points (TRP). The ng-eNB and an access and mobility management function (AMF) entity are connected through a NG-C interface. The gNB and the AMF entity are connected through a NG-C interface. The AMF entity and a location management function (LMF) are connected through a NL1 interface.

Specifically, in FIG. 4, the LMF is the LCS server, and the LCS client transmits a location request to the AMF. During positioning, the LMF may initiate a positioning procedure to the UE and the gNB, for example, to obtain location-related measurements and auxiliary information. Two NR-related positioning protocols are the LTE positioning protocol (LPP) and the NR positioning protocol a (NRPPa). As a general positioning communication protocol, the LPP is mainly used for exchanging positioning capability information, auxiliary data, positioning-related measurement information, and location information between the LCS server and the UE, and the LPP supports point-to-point communication between the UE and the LCS server. The LPP can be used for user-plane positioning and control-plane positioning, and allows multiple LPP processes to be executed simultaneously to reduce latency. The NRPPa is only used for control-plane positioning, supports communication between the gNB and the LCS server, and can help user-plane positioning by querying data and measurements of the gNB.

For better understanding of embodiments of the disclosure, a multiple round trip time (multi-RTT) positioning method related to the disclosure is described.

Multi-RTT is a positioning method combining UL positioning and DL positioning which has high positioning accuracy. A terminal (UE) and multiple base stations (or TRPs) can transmit reference signals to each other, and the location of the UE can be determined based on a time difference between reception of the signal and transmission of the signal at the UE, a time difference between reception of the signal and transmission of the signal at the gNB, and ULAOA, and other data. Although requiring the configuration of both UL and DL reference signals, this positioning method is not affected by the inter-station synchronization accuracy. A round trip time (RTT) algorithm decomposes a transmission time from the base station to the UE into two parts, and calculates a RTT based on measurement results of these two parts.

In the RTT procedure, both the UE and the transmitting node (base station) are required to measure a time of arrival (TOA). For a DL signal, the base station records a transmission time to by using the local clock of the base station, and the terminal measures a time of arrival t1 of the DL signal by using the local clock of the terminal. For a UL signal, the terminal records a transmission time t2 by using the local clock of the terminal, and the base station measures a time of arrival t3 of the UL signal by using the local clock of the base station. Finally, a round-trip time measured by the system is (t3-t0)-(t2-t1). A time difference between reception of the signal and transmission of the signal is t3-t0, and a time difference corresponding to the gNB is t2-t1. Since the time differences between reception of the signal and transmission of the signal at the gNB and the UE are relative time differences, and reference clocks of the gNB and the UE are the local clocks of the terminal and the base station. Therefore, for the RTT positioning technology, the base station and the terminal are not required to be synchronized.

For better understanding of embodiments of the disclosure, the problem solved by the disclosure is described.

Current positioning algorithms such as downlink time difference of arrival (DL-TDOA), uplink time difference of arrival (UL-TDOA), or multi-RTT require multiple base stations or TRPs for joint positioning, which is feasible for ground networks. However, in NTN scenarios, the UE is usually unable to transmit/receive signals to/from multiple satellites simultaneously. In a more realistic scenario, at the same moment, the UE can only communicate with one satellite. How to position through one satellite is a problem to be solved.

Based on the above problem, a terminal positioning solution is proposed in the disclosure. A scenario where base stations (or TRPs) at different locations determine a terminal location is simulated by introducing TA values at different moments. As such, location information of a terminal device can be determined based on the TA values at different moments, and satellite-based terminal positioning can be realized.

The technical solution of the disclosure is described in detail below in specific embodiments.

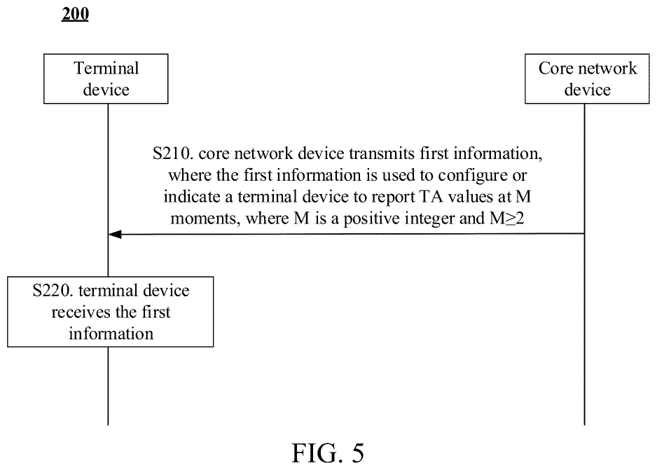

FIG. 5 is a schematic flowchart of a wireless communication method 200 according to embodiments of the disclosure. As illustrated in FIG. 5, the wireless communication method 200 may include at least part of the following.

S210. A core network device transmits first information, where the first information is used to configure or indicate a terminal device to report timing advance (TA) values at M moments, where M is a positive integer and M≥2.

S220. A terminal device receives the first information.

In embodiments of the disclosure, the core network device can configure or indicate the terminal device to report TA values at M moments, which simulates a scenario where base stations (or TRPs) at different locations determine a terminal location (i.e., multi-RTT positioning). As such, the core network device can determine location information of the terminal device based on the TA values at different moments, and satellite-based terminal positioning can be realized.

Specifically, in embodiments of the disclosure, each TA report by the terminal device can be understood as one RTT report, that is, TA value reports at different moments can be understood as multi-RTT reporting.

That is, the core network device can configure the terminal device to perform TA reporting at different moments. According to the configuration by the core network device, the terminal device records TAs and reports TA values and other auxiliary information to the core network device at different moments. As such, the core network device can determine the location information of the terminal device based on information reported by the terminal device.

In some embodiments, the M moments are moments with respect to a same satellite cell. That is, the first information is used to configure or indicate the terminal device to report the TA values at the M moments with respect to the same satellite cell.

Specifically, the M moments with respect to the same satellite cell can be understood as M moments at which the terminal device is in the same satellite cell, that is, M moments at which a communication link is established between the terminal device and the same satellite.

In some embodiments, the M moments are moments with respect to multiple satellite cells. That is, the first information is used to configure or indicate the terminal device to report the TA values at the M moments with respect to the multiple satellite cells.

Specifically, the M moments with respect to the multiple satellite cells can be understood as M moments at which the terminal device is successively in the multiple satellite cells, that is, M moments at which communication links are established between the terminal device and the multiple satellites successively.

In some embodiments, the first information is location information request information. Of course, the first information can be other information, which is not limited in embodiments of the disclosure.

In some embodiments, the first information is carried by an LPP message. Of course, the first information can be carried by other messages or signalings, which is not limited in embodiments of the disclosure.

In some embodiments, the core network device is an LMF entity, or the core network device is an AMF entity. Of course, the core network device can be other core network elements, which is not limited in embodiments of the disclosure.

In some embodiments, embodiments of the disclosure can also be applied to a scenario with multiple satellites. That is, the core network device can configure or indicate the terminal device to record and report TA values at multiple moments with respect to multiple satellite cells, and the core network device can determine location information of the terminal device based on the TA values at different moments. In this case, the core network device needs to notify the terminal device of ephemeris information of the multiple satellites.

In some embodiments, the M moments are arranged at equal intervals. That is, the core network device can configure or indicate the terminal device to report TA values at equal time intervals, or the core network device can configure or indicate the terminal device to report TA values periodically.

In some embodiments, the M moments are arranged at unequal intervals. That is, the core network device can configure or indicate the terminal device to report TA values at unequal time intervals, or the core network device can configure or indicate the terminal device to report TA values aperiodically.

In some embodiments, a time interval between adjacent moments among the M moments is at least one of: at least one subframe, at least one radio frame, at least one slot, at least one symbol, at least one second, or at least one millisecond.

For example, the interval between different moments may be a certain number of DL subframes, radio frames, slots, or symbols.

For another example, the interval between different moments may be a certain number of radio frames and subframes. Alternatively, the interval between different moments may be a certain number of subframes and slots. Alternatively, the interval between different moments may be a certain number of slots and symbols. Alternatively, the interval between different moments may be a certain number of subframes, slots, and symbols.

For another example, the interval between different moments may be a certain number of seconds or milliseconds. That is, the interval between different moments may be an absolute time or a relative time.

In some embodiments, in response to the M moments being arranged at equal intervals, the first information includes at least one of: time information of a 1st moment among the M moments, or information of a time interval between adjacent moments among the M moments. For example, the core network device can configure or indicate a time interval (delta-t) and a 1st moment t0, and the terminal device can determine a moment when a TA needs to be recorded and reported based on t0 and delta-t.

In some embodiments, in response to the M moments being arranged at unequal intervals, the first information includes at least one of: time information of a 1st moment among the M moments, or information of a time interval between the 1st moment and another moment among the M moments other than the 1st moment. For example, the core network device can configure or indicate a 1st moment t0 and multiple time intervals relative to the 1st moment, such as delta-t1, delta-t2, delta-t3, . . . , and the terminal device can determine a moment when a TA needs to be recorded and reported based on t0 and delta-t1, delta-t2, delta-t3, etc.

Specifically, the introduction of the time interval increases the independence of measurements at adjacent moments, thereby avoiding positioning failure or poor positioning accuracy due to short intervals between measurements.

In some embodiments, TA values at adjacent moments among the M moments differ by one TA deviation threshold. For example, the terminal device records a 1st TA value at a certain moment, records a 2nd TA value at a moment when the TA change relative to the 1st TA value reaches the TA deviation threshold, records a 3rd TA value at a moment when the TA change relative to the 2nd TA value reaches the TA deviation threshold, and so on, until TA recording and reporting requirements configured by the core network are met.

In some embodiments, the TA deviation threshold is configured by a network device, or the TA deviation threshold is specified in a protocol.

Optionally, in a case where the TA deviation threshold is configured by a network device, the first information may include the TA deviation threshold. That is, the core network device can configure the TA deviation threshold through the first information.

In some embodiments, the terminal device transmits a first measurement result, where the first measurement result includes the TA values at the M moments.

The specific interaction process may be as follows. The terminal device transmits the first measurement result, the core network device receives the first measurement result, and the core network device can determine location information of the terminal device based on the first measurement result. The first measurement result may be forwarded by one or more network elements and finally obtained by the core network device.

In some embodiments, the first measurement result further includes but is not limited to at least one of: time information for each TA value recording, information of a satellite for each TA value recording, or a reference signal received power (RSRP) measurement result for each TA value recording.

In some embodiments, the information of the satellite for each TA value recording includes but is not limited to at least one of: location information of the satellite, ephemeris information of the satellite, identification information of the satellite, a feeder link delay, a common TA value, or a Kmac value.

It should be noted that the location of the satellite can be similar to the location of the base station or the TRP in multi-RTT positioning. In the positioning, the location of the terminal device is mainly determined according to the propagation difference of service links, but a real TA value of the terminal device contains the influence of a propagation delay of a feeder link. Therefore, the influence of the feeder link needs to be eliminated in actual positioning.

In some embodiments, feeder link delay=common TA+Kmac. In the feeder link, the UL timing and the DL timing are aligned.

Optionally, the value of common TA may be obtained through a common TA parameter broadcast by a current serving cell.

Optionally, Kmac is obtained through a Kmac parameter broadcast by the current serving cell. Kmac can reflect a delay from the base station to a reference point.

In some embodiments, the RSRP measurement result for each TA value recording may be, for example, an RSRP value measured based on a synchronization signal block (SSB) signal, or an RSRP value measured based on a positioning reference signal (PRS), or an RSRP value measured based on a channel state information reference signal (CSI-RS).

In some embodiments, the terminal device transmits the first measurement result in response to a first condition being met, where the first condition includes at least one of: reaching a number of TA recording, reaching a TA recording duration, reaching a TA recording end moment, reaching a TA reporting response moment, or a TA value change exceeding a TA deviation threshold.

In other words, the first measurement result is transmitted by the terminal device when the first condition is met.

In some embodiments, the first information further includes but is not limited to at least one of: the number of TA recording, the TA recording duration, the TA recording end moment, the TA reporting response moment, or the TA deviation threshold.

Optionally, the number of recording can be determined based on the TA recording duration and a recording interval.

It should be noted that part or all of the number of TA recording, the TA recording duration, the TA recording end moment, the TA reporting response moment, or the TA deviation threshold can be obtained through other information other than the first information, which is not limited in embodiments of the disclosure.

In some embodiments, the first measurement result is carried by a long term evolution positioning protocol (LPP) message.

In some embodiments, the core network device determines location information of the terminal device according to the first measurement result. It should be noted that the core network device may refer to some other information when determining the location information of the terminal device, which is not limited in the disclosure.

In some embodiments, the TA value is a TA value of the terminal device, or the TA value is a TA value of a service link.

In some embodiments, the TA value of the service link is determined based on the TA value of the terminal device, a common TA value, and a Kmac value.

In some embodiments, the TA value of the service link may be a TA adjustment value, such as N_{TA,adj}^{UE} as defined in the RAN1 protocol, calculated by the terminal device according to the location of the terminal device and ephemeris information corresponding to a satellite cell.

It should be noted that the feeder link refers to a radio link between the satellite and the NTN gateway (usually located on the ground). The service link refers to a radio link between the terminal device and the satellite.

In some embodiments, the TA values at the M moments are reported in same information, or the TA value at each of the M moments is reported separately. That is, TA values recorded at multiple times can be reported in one message, or a single TA value result can be reported at each time.

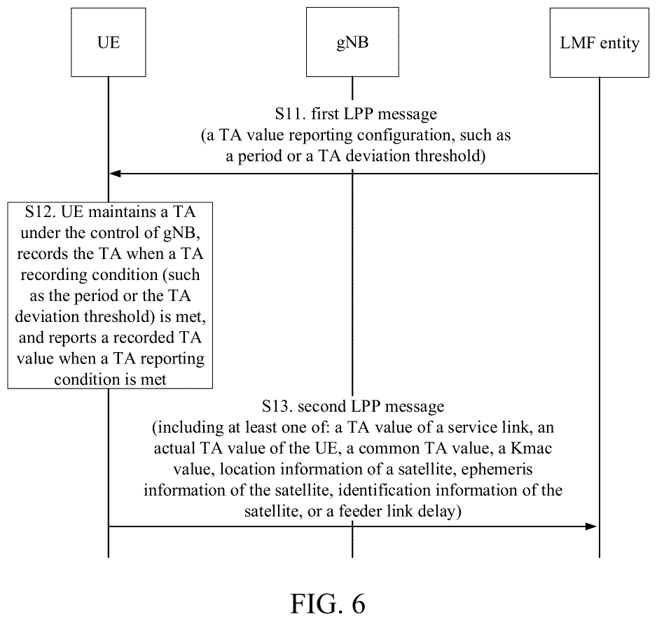

The following describes in detail through an embodiment how the core network device determines the location information of the terminal device based on the measurement result reported by the terminal device. For example, the core network device is an LMF entity. As illustrated in FIG. 6, this is specifically implemented through S11 to S13.

S11. The LMF entity transmits a first LPP message, where the first LPP message may include a TA value reporting configuration, such as a TA reporting period or a TA deviation threshold.

S12. A UE maintains a TA under the control of a gNB, records the TA when a TA recording condition (such as the TA reporting period or the TA deviation threshold) is met, and reports a recorded TA value when a TA reporting condition (i.e., a first condition) is met.

S13. The UE transmits a second LPP message, where the second LPP message may include but is not limited to at least one of: a TA value of a service link (at one or more moments), an actual TA value of the UE (at one or more moments), a common TA value, a Kmac value, location information of a satellite, ephemeris information of the satellite, identification information of the satellite, or a feeder link delay.

Furthermore, the LMF entity can determine the location information of the terminal device based on the content contained in the second LPP message.

Therefore, in embodiments of the disclosure, the core network device can configure or indicate the terminal device to report TA values at M moments, which simulates a scenario where base stations (or TRPs) at different locations determine a terminal location. As such, the core network device can determine location information of the terminal device based on the TA values at different moments, and satellite-based terminal positioning can be realized.

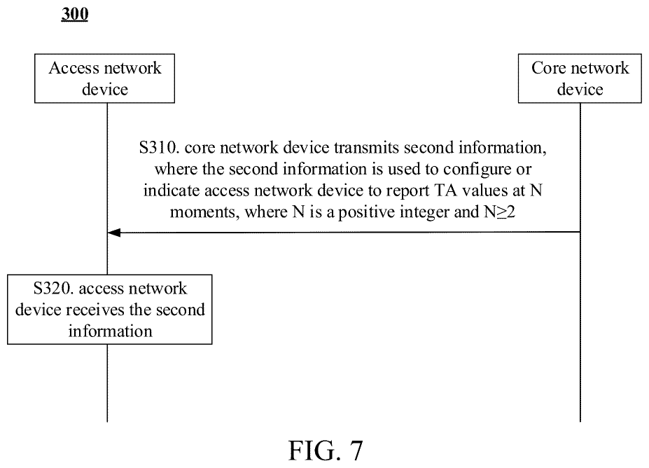

FIG. 7 is a schematic flowchart of a wireless communication method 300 according to embodiments of the disclosure. As illustrated in FIG. 7, the wireless communication method 300 may include at least part of the following.

S310. A core network device transmits second information, where the second information is used to configure or indicate an access network device to report TA values at N moments, where N is a positive integer and N≥2.

S320. An access network device receives the second information.

In embodiments of the disclosure, the core network device can configure or indicate the access network device to report TA values at N moments, which simulates a scenario where base stations (or TRPs) at different locations determine a terminal location (i.e., multi-RTT positioning). As such, the core network device can determine location information of the terminal device based on the TA values at different moments, and satellite-based terminal positioning is realized.

Specifically, in embodiments of the disclosure, each TA report by the access network device can be understood as one RTT report, that is, TA value reports at different moments can be understood as multi-RTT reporting.

That is, the core network device can configure the access network device to perform TA reporting at different moments. According to the configuration by the core network device, at different moments, the access network device records TAs and reports TA values and other auxiliary information to the core network device. As such, the core network device can determine the location information of the access network device based on information reported by the access network device.

It should be noted that the access network device can also be referred to as a base station, which is not limited in embodiments of the disclosure.

In some embodiments, the N moments are moments with respect to a same satellite cell. That is, the second information is used to configure or indicate the access network device to report the TA values at the N moments with respect to the same satellite cell.

Specifically, the N moments with respect to the same satellite cell can be understood as N moments at which the terminal device is in the same satellite cell, that is, N moments at which a communication link is established between the terminal device and the same satellite.

In some embodiments, the N moments are moments with respect to multiple satellite cells. That is, the second information is used to configure or indicate the access network device to report the TA values at the N moments with respect to the multiple satellite cells.

Specifically, the N moments with respect to the multiple satellite cells can be understood as N moments at which the terminal device is successively in the multiple satellite cells, that is, N moments at which communication links are established between the terminal device and the multiple satellites successively.

In some embodiments, the second information is measurement request information. Of course, the second information can be other information, which is not limited in embodiments of the disclosure.

In some embodiments, the second information is carried by an NRPPa message. Of course, the second information can be carried by other messages or signalings, which is not limited in embodiments of the disclosure.

In some embodiments, the core network device is an LMF entity, or the core network device is an AMF entity. Of course, the core network device can be other core network elements, which is not limited in embodiments of the disclosure.

In some embodiments, embodiments of the disclosure can also be applied to a scenario with multiple satellites. That is, the core network device can configure or indicate the access network device to record and report TA values at multiple moments with respect to multiple satellite cells, and the core network device can determine location information of the terminal device based on the TA values at different moments. In this case, the core network device needs to notify the terminal device of ephemeris information of the multiple satellites.

In some embodiments, the N moments are arranged at equal intervals. That is, the core network device can configure or indicate the access network device to record and report TA values at equal time intervals, or the core network device can configure or indicate the access network device to record and report TA values periodically.

In some embodiments, the N moments are arranged at unequal intervals. That is, the core network device can configure or indicate the access network device to report TA values at unequal time intervals, or the core network device can configure or indicate the core network device to report TA values aperiodically.

In some embodiments, a time interval between adjacent moments among the N moments is at least one of: at least one subframe, at least one radio frame, at least one slot, at least one symbol, at least one second, or at least one millisecond.

For example, the interval between different moments may be a certain number of DL subframes, radio frames, slots, or symbols.

For another example, the interval between different moments may be a certain number of radio frames and subframes. Alternatively, the interval between different moments may be a certain number of subframes and slots. Alternatively, the interval between different moments may be a certain number of slots and symbols. Alternatively, the interval between different moments may be a certain number of subframes, slots, and symbols.

For another example, the interval between different moments may be a certain number of seconds or milliseconds. That is, the interval between different moments may be an absolute time or a relative time.

In some embodiments, in response to the N moments being arranged at equal intervals, the second information includes at least one of: time information of a 1st moment among the N moments, or information of a time interval between adjacent moments among the N moments. For example, the core network device can configure or indicate a time interval (delta-t) and a 1st moment t0, and the access network device can determine a moment when a TA needs to be recorded and reported based on t0 and delta-t.

In some embodiments, in response to the N moments being arranged at unequal intervals, the second information includes at least one of: the time information of the 1st moment among the N moments, or information of a time interval between the 1st moment and another moment among the N moments other than the 1st moment. For example, the core network device can configure or indicate a 1st moment t0 and multiple time intervals relative to the 1st moment, such as delta-t1, delta-t2, delta-t3, . . . , and the access network device can determine a moment when a TA needs to be recorded and reported based on t0 and delta-t1, delta-t2, delta-t3, etc.

Specifically, the introduction of the time interval increases the independence of measurements at adjacent moments, thereby avoiding positioning failure or poor positioning accuracy due to short intervals between measurements.

In some embodiments, TA values at adjacent moments among the N moments differ by one TA deviation threshold. For example, the access network device records a 1st TA value at a certain moment, records a 2nd TA value at a moment when the TA change relative to the 1st TA value reaches the TA deviation threshold, records a 3rd TA value at a moment when the TA change relative to the 2nd TA value reaches the TA deviation threshold, and so on, until TA recording and reporting requirements configured by the core network are met.

In some embodiments, the TA deviation threshold is configured by a network device, or the TA deviation threshold is specified in a protocol.

Optionally, in a case where the TA deviation threshold is configured by a network device, the second information may include the TA deviation threshold. That is, the core network device can configure the TA deviation threshold through the second information.

In some embodiments, the access network device transmits third information, where the third information is used to configure a terminal device to report a TA value, and the third information is determined based on the second information.

Specifically, after receiving the second information, the access network device can configure the terminal device to report a TA value based on the second information. Optionally, the third information may be carried by an RRC signaling.

The specific interaction process may be as follows. The access network device transmits the third information, and the terminal device receives the third information, and the terminal device reports the TA value based on the third information.

In some embodiments, the third information is specifically used to configure the terminal device to report the TA value periodically, and the third information includes a period for the terminal device to report the TA value. That is, the terminal device can report the TA value periodically based on the third information.

In some embodiments, the third information is specifically used to configure the terminal device to report the TA value based on a TA deviation threshold, and the third information includes the TA deviation threshold. That is, the terminal device is triggered to report a TA value when the TA change reaches the TA deviation threshold. Optionally, TA values at adjacent moments reported by the terminal device differ by one TA deviation threshold. For example, the terminal device reports a 1st TA value at a certain moment, reports a 2nd TA value at a moment when the TA change relative to the 1st TA value reaches the TA deviation threshold, reports a 3rd TA value at a moment when the TA change relative to the 2nd TA value reaches the TA deviation threshold, and so on, until TA reporting requirements configured by the access network are met.

In embodiments of the disclosure, the TA value reported by the terminal device needs to at least meet recording and reporting requirements of the access network device.

In some embodiments, the access network device receives and records a TA value reported by a terminal device through an RRC signaling.

In some embodiments, the access network device transmits a second measurement result, where the second measurement result includes the TA values at the N moments.

The specific interaction process may be as follows. The access network device transmits the second measurement result, the core network device receives the second measurement result, and the core network device can determine location information of the terminal device based on the second measurement result. The second measurement result may be forwarded by one or more network elements and finally obtained by the core network device.

In some embodiments, the second measurement result further includes but is not limited to at least one of: information of a satellite for each TA value recording, or a RSRP measurement result obtained based on sounding reference signal (SRS) measurement.

In some embodiments, the information of the satellite for each TA value recording includes but is not limited to at least one of: location information of the satellite, ephemeris information of the satellite, identification information of the satellite, a feeder link delay, a common TA value, or a Kmac value.

It should be noted that the location of the satellite can be similar to the location of the base station or the TRP in multi-RTT positioning. In the positioning, the location of the terminal device is mainly determined according to the propagation difference of service links, but a real TA value of the terminal device contains the influence of a propagation delay of a feeder link. Therefore, the influence of the feeder link needs to be eliminated in actual positioning.

In some embodiments, feeder link delay=common TA+Kmac. On the feeder link, the UL timing and the DL timing are aligned.

Optionally, the value of the common TA may be obtained through a common TA parameter broadcast by a current serving cell.

Optionally, Kmac is obtained through a Kmac parameter broadcast by the current serving cell. Kmac can reflect a delay from the base station to a reference point.

In some embodiments, the access network device transmits the second measurement result in response to a second condition being met, where the second condition includes at least one of: reaching a number of TA recording, reaching a TA recording duration, reaching a TA recording end moment, or reaching a TA reporting response moment.

In other words, the second measurement result is transmitted by the access network device when the second condition is met.

In some embodiments, the second information further includes but is not limited to at least one of: the number of TA recording, the TA recording duration, the TA recording end moment, or the TA reporting response moment.

Optionally, the number of recording can be determined based on the TA recording duration and a recording interval.

It should be noted that part or all of the number of TA recording, the TA recording duration, the TA recording end moment, the TA reporting response moment, or the TA deviation threshold can be obtained through other information other than the second information, which is not limited in embodiments of the disclosure.

In some embodiments, the second measurement result is carried by a new radio positioning protocol a (NRPPa) message.

In some embodiments, the core network device determines location information of the terminal device according to the second measurement result. It should be noted that the core network device may refer to some other information when determining the location information of the terminal device, which is not limited in the disclosure.

In some embodiments, the TA value is a TA value of the terminal device, or the TA value is a TA value of a service link.

In some embodiments, the TA value of the service link may be a TA adjustment value, such as NUE NTA, adj as defined in the RANI protocol, calculated by the terminal device according to the location of the terminal device and ephemeris information corresponding to a satellite cell.

It should be noted that the feeder link refers to a radio link between the satellite and the NTN gateway (usually located on the ground). The service link refers to a radio link between the terminal device and the satellite.

In some embodiments, multiple measurement results are reported in same information, or a TA value of each measurement result among the multiple measurement results is reported separately, where the multiple measurement results include at least the second measurement result. That is, measurement results reported at multiple times can be reported in one message, or a single measurement result can be reported at each time.

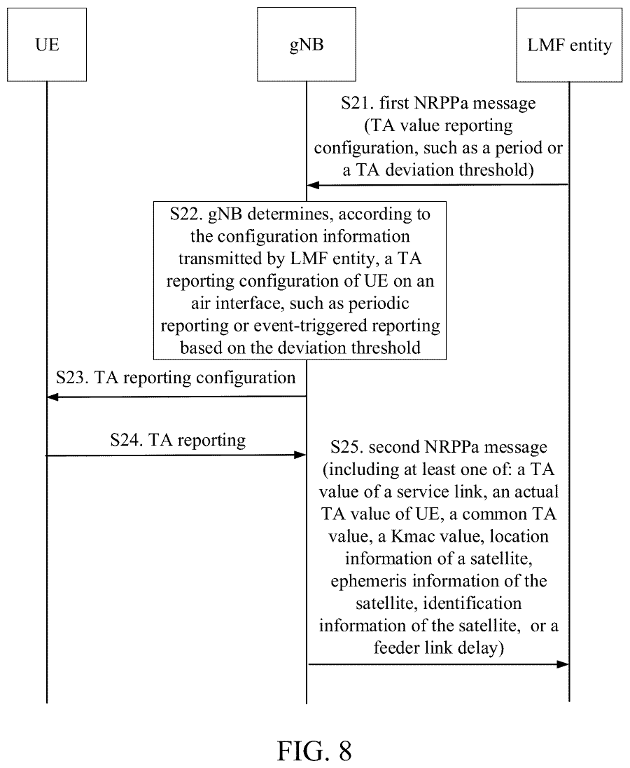

The following describes in detail through an embodiment how the core network device determines the location information of the terminal device based on the measurement result reported by the access network device. For example, the core network device is an LMF entity and the access network device is a gNB. As illustrated in FIG. 8, this is specifically implemented through S21 to S25.

S21. The LMF entity transmits a first NRPPa message, where the first NRPPa message may include a TA value reporting configuration, such as a TA reporting period or a TA deviation threshold.

S22. The gNB determines, according to the configuration information transmitted by the LMF entity, a TA reporting configuration of the UE on an air interface (RRC message), such as periodic reporting (such as reporting TA values by the terminal device periodically) or event-triggered reporting based on the deviation threshold (such as triggering the UE to report a TA value when the TA change reaches the TA deviation threshold).

S23. The gNB transmits the TA reporting configuration to UE.

S24. The UE performs TA reporting.

S25. The gNB transmits a second NRPPa message, where the second NRPPa message may include but is not limited to at least one of: a TA value of a service link (at one or more moments), an actual TA value of the UE (at one or more moments), a common TA value, a Kmac value, location information of a satellite, ephemeris information of the satellite, identification information of the satellite, or a feeder link delay.

Optionally, the gNB transmits the second NRPPa message in a case where a second condition is met.

Furthermore, the LMF entity can determine the location information of the terminal device based on the content contained in the second NRPPa message.

Therefore, in embodiments of the disclosure, the core network device can configure or indicate the access network device to record and report TA values at N moments with respect to the same satellite cell, which simulates a scenario where base stations (or TRPs) at different locations determine a terminal location. As such, the core network device can determine the location information of the terminal device based on the TA values at different moments, and satellite-based terminal positioning is realized.

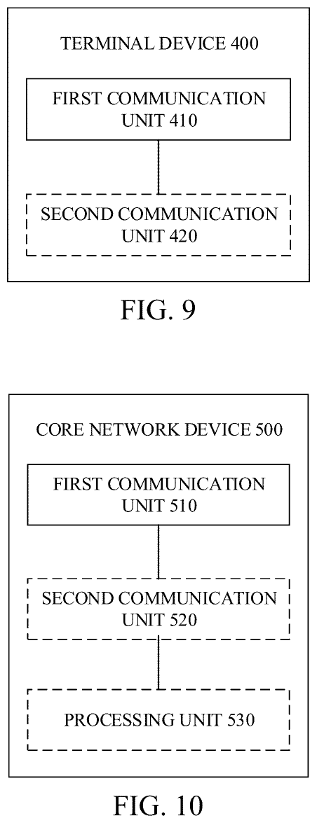

The method embodiments of the disclosure are described in detail above with reference to FIG. 5 to FIG. 8, and the apparatus embodiments of the disclosure will be described in detail below with reference to FIG. 9 to FIG. 12. It should be understood that, the apparatus embodiments and the method embodiments correspond to each other, and for similar content, reference can be made to the method embodiments.

FIG. 9 illustrates a schematic block diagram of a terminal device 400 according to embodiments of the disclosure. As illustrated in FIG. 9, the terminal device 400 includes a first communication unit 410. The first communication unit 410 is configured to receive first information, where the first information is used to configure or indicate the terminal device to report TA values at M moments, where M is a positive integer and M≥2.

In some embodiments, the M moments are arranged at equal intervals, or the M moments are arranged at unequal intervals.

In some embodiments, a time interval between adjacent moments among the M moments is at least one of: at least one subframe, at least one radio frame, at least one slot, at least one symbol, at least one second, or at least one millisecond.

In some embodiments, in response to the M moments being arranged at equal intervals, the first information includes at least one of: time information of a 1st moment among the M moments, or information of a time interval between adjacent moments among the M moments; or in response to the M moments being arranged at unequal intervals, the first information includes at least one of: time information of a 1st moment among the M moments, or information of a time interval between the 1st moment and another moment among the M moments other than the 1st moment.

In some embodiments, TA values at adjacent moments among the M moments differ by one TA deviation threshold.

In some embodiments, the terminal device 400 further includes a second communication unit 420. The second communication unit 420 is configured to transmit a first measurement result, where the first measurement result includes the TA values at the M moments.

In some embodiments, the first measurement result further includes at least one of: time information for each TA value recording, information of a satellite for each TA value recording, or a RSRP measurement result for each TA value recording.

In some embodiments, the information of the satellite for each TA value recording includes at least one of: location information of the satellite, ephemeris information of the satellite, identification information of the satellite, a feeder link delay, a common TA value, or a Kmac value.

In some embodiments, the second communication unit 420 is specifically configured to: transmit the first measurement result in response to a first condition being met, where the first condition includes at least one of: reaching a number of TA recording, reaching a TA recording duration, reaching a TA recording end moment, reaching a TA reporting response moment, or a TA value change exceeding a TA deviation threshold.

In some embodiments, the first information further includes at least one of: the number of TA recording, the TA recording duration, the TA recording end moment, the TA reporting response moment, or the TA deviation threshold.

In some embodiments, the first measurement result is carried by an LPP message.

In some embodiments, the TA deviation threshold is configured by a network device, or the TA deviation threshold is specified in a protocol.

In some embodiments, the TA value is a TA value of the terminal device, or the TA value is a TA value of a service link.

In some embodiments, the TA values at the M moments are reported in same information, or the TA value at each of the M moments is reported separately.

In some embodiments, the M moments are moments with respect to a same satellite cell, or the M moments are moments with respect to multiple satellite cells.

In some embodiments, the first information is location information request information.

In some embodiments, the first information is carried by an LPP message.

In some embodiments, the communication unit may be a communication interface or a transceiver, or an input/output interface of a communication chip or a system-on-chip (SOC). The processing unit may be one or more processors.

It should be understood that, the terminal device 400 according to embodiments of the disclosure may correspond to the terminal device in the method embodiments of the disclosure, and the foregoing and other operations and/or functions of various units in the terminal device 400 are respectively intended for implementing corresponding operations of the terminal device in the method 200 illustrated in FIG. 5, which will not be described again herein for the sake of brevity.

FIG. 10 illustrates a schematic block diagram of a core network device 500 according to embodiments of the disclosure. As illustrated in FIG. 10, the core network device 500 includes a first communication unit 510. The first communication unit 510 is configured to transmit first information, where the first information is used to configure or indicate a terminal device to report TA values at M moments, where M is a positive integer and M≥2.

In some embodiments, the M moments are arranged at equal intervals, or the M moments are arranged at unequal intervals.

In some embodiments, a time interval between adjacent moments among the M moments is at least one of: at least one subframe, at least one radio frame, at least one slot, at least one symbol, at least one second, or at least one millisecond.

In some embodiments, in response to the M moments being arranged at equal intervals, the first information includes at least one of: time information of a 1st moment among the M moments, or information of a time interval between adjacent moments among the M moments; or in response to the M moments being arranged at unequal intervals, the first information includes at least one of: time information of a 1st moment among the M moments, or information of a time interval between the 1st moment and another moment among the M moments other than the 1st moment.

In some embodiments, TA values at adjacent moments among the M moments differ by one TA deviation threshold.

In some embodiments, the core network device 500 further includes a second communication unit 520. The second communication unit 520 is configured to receive a first measurement result, where the first measurement result includes the TA values at the M moments.

In some embodiments, the first measurement result further includes at least one of: time information for each TA value recording, information of a satellite for each TA value recording, or a RSRP measurement result for each TA value recording.

In some embodiments, the information of the satellite for each TA value recording includes at least one of: location information of the satellite, ephemeris information of the satellite, identification information of the satellite, a feeder link delay, a common TA value, or a Kmac value.

In some embodiments, the first measurement result is transmitted by the terminal device in response to a first condition being met, where the first condition includes at least one of: reaching a number of TA recording, reaching a TA recording duration, reaching a TA recording end moment, reaching a TA reporting response moment, or a TA value change exceeding a TA deviation threshold.

In some embodiments, the first information further includes at least one of: the number of TA recording, the TA recording duration, the TA recording end moment, the TA reporting response moment, or the TA deviation threshold.

In some embodiments, the first measurement result is carried by an LPP message.

In some embodiments, the core network device 500 further includes a processing unit 530. The processing unit 530 is configured to determine location information of the terminal device according to the first measurement result.

In some embodiments, the TA deviation threshold is configured by a network device, or the TA deviation threshold is specified in a protocol.

In some embodiments, the TA value is a TA value of the terminal device, or the TA value is a TA value of a service link.

In some embodiments, the TA values at the M moments are reported in same information, or the TA value at each of the M moments is reported separately.

In some embodiments, the M moments are moments with respect to a same satellite cell, or the M moments are moments with respect to multiple satellite cells.

In some embodiments, the first information is location information request information.

In some embodiments, the first information is carried by an LPP message.

In some embodiments, the core network device is a location management function (LMF) entity, or the core network device is an access and mobility management function (AMF) entity.

In some embodiments, the communication unit may be a communication interface or a transceiver, or an input/output interface of a communication chip or a system-on-chip (SOC). The processing unit may be one or more processors.

It should be understood that, the core network device 500 according to embodiments of the disclosure may correspond to the core network device in the method embodiments of the disclosure, and the foregoing and other operations and/or functions of various units in the core network device 500 are respectively intended for implementing corresponding operations of the core network device in the method 200 illustrated in FIG. 5, which will not be described again herein for the sake of brevity.

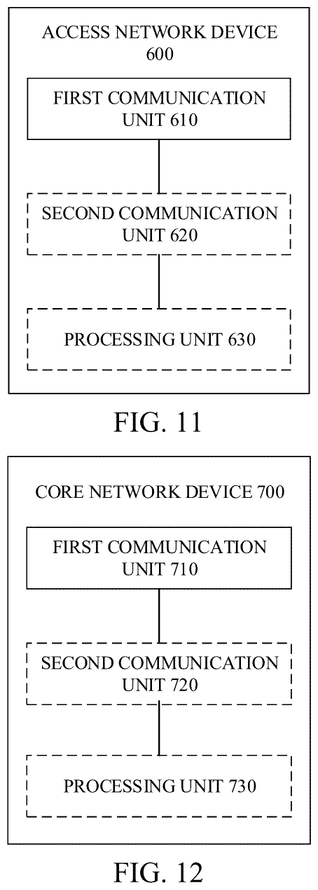

FIG. 11 illustrates a schematic block diagram of an access network device 600 according to embodiments of the disclosure. As illustrated in FIG. 11, the access network device 600 includes a first communication unit 610. The first communication unit 610 is configured to receive second information, where the second information is used to configure or indicate the access network device to report TA values at N moments, where N is a positive integer and N≥2.

In some embodiments, the N moments are arranged at equal intervals, or the N moments are arranged at unequal intervals.

In some embodiments, a time interval between adjacent moments among the N moments is at least one of: at least one subframe, at least one radio frame, at least one slot, at least one symbol, at least one second, or at least one millisecond.

In some embodiments, in response to the N moments being arranged at equal intervals, the second information includes at least one of: time information of a 1st moment among the N moments, or information of a time interval between adjacent moments among the N moments; or in response to the N moments being arranged at unequal intervals, the second information includes at least one of: the time information of the 1st moment among the N moments, or information of a time interval between the 1st moment and another moment among the N moments other than the 1st moment.

In some embodiments, TA values at adjacent moments among the N moments differ by one TA deviation threshold.

In some embodiments, the second information includes the TA deviation threshold.

In some embodiments, the access network device 600 further includes a second communication unit 620. The second communication unit 620 is configured to transmit third information, where the third information is used to configure a terminal device to report a TA value, and the third information is determined based on the second information.

In some embodiments, the third information is specifically used to configure the terminal device to report the TA value periodically, and the third information includes a period for the terminal device to report the TA value.

In some embodiments, the third information is specifically used to configure the terminal device to report the TA value based on a TA deviation threshold, and the third information includes the TA deviation threshold.

In some embodiments, the access network device 600 further includes a processing unit 630. The first communication unit 610 is further configured to receive a TA value reported by a terminal device through an RRC signaling, and the processing unit 630 is configured to record the TA value reported by the terminal device through the RRC signaling.

In some embodiments, the access network device 600 further includes a second communication unit 620. The second communication unit 620 is configured to transmit a second measurement result, where the second measurement result includes the TA values at the N moments.

In some embodiments, the second measurement result further includes at least one of: information of a satellite for each TA value recording, or a RSRP measurement result obtained based on SRS measurement.

In some embodiments, the information of the satellite for each TA value recording includes at least one of: location information of the satellite, ephemeris information of the satellite, identification information of the satellite, a feeder link delay, a common TA value, or a Kmac value.

In some embodiments, the second communication unit 620 is specifically configured to: transmit the second measurement result in response to a second condition being met, where the second condition includes at least one of: reaching a number of TA recording, reaching a TA recording duration, reaching a TA recording end moment, or reaching a TA reporting response moment.

In some embodiments, the second information further includes at least one of: the number of TA recording, the TA recording duration, the TA recording end moment, or the TA reporting response moment.

In some embodiments, the second measurement result is carried by a new radio positioning protocol a (NRPPa) message.

In some embodiments, multiple measurement results are reported in same information, or a TA value of each measurement result among the multiple measurement results is reported separately, where the multiple measurement results include at least the second measurement result.

In some embodiments, the TA value is a TA value of a terminal device, or the TA value is a TA value of a service link.

In some embodiments, the TA value of the service link is determined based on the TA value of the terminal device, a common TA value, and a Kmac value.

In some embodiments, the N moments are moments with respect to a same satellite cell, or the N moments are moments with respect to multiple satellite cells.

In some embodiments, the second information is measurement request information.

In some embodiments, the second information is carried by an NRPPa message.

In some embodiments, the communication unit may be a communication interface or a transceiver, or an input/output interface of a communication chip or a system-on-chip (SOC).

The processing unit may be one or more processors.

It should be understood that, the access network device 600 according to embodiments of the disclosure may correspond to the access network device in the method embodiments of the disclosure, and the foregoing and other operations and/or functions of various units in the access network device 600 are respectively intended for implementing corresponding operations of the access network device in the method 300 illustrated in FIG. 7, which will not be described again herein for the sake of brevity.

FIG. 12 illustrates a schematic block diagram of a core network device 700 according to embodiments of the disclosure. As illustrated in FIG. 12, the core network device 700 includes a first communication unit 710. The first communication unit 710 is configured to transmit second information, where the second information is used to configure or indicate an access network device to report TA values at N moments, where N is a positive integer and N≥2.

In some embodiments, the N moments are arranged at equal intervals, or the N moments are arranged at unequal intervals.

In some embodiments, a time interval between adjacent moments among the N moments is at least one of: at least one subframe, at least one radio frame, at least one slot, at least one symbol, at least one second, or at least one millisecond.

In some embodiments, in response to the N moments being arranged at equal intervals, the second information includes at least one of: time information of a 1st moment among the N moments, or information of a time interval between adjacent moments among the N moments; or in response to the N moments being arranged at unequal intervals, the second information includes at least one of: the time information of the 1st moment among the N moments, or information of a time interval between the 1st moment and another moment among the N moments other than the 1st moment.

In some embodiments, TA values at adjacent moments among the N moments differ by one TA deviation threshold.

In some embodiments, the second information includes the TA deviation threshold.

In some embodiments, the core network device 700 further includes a second communication unit 720. The second communication unit 720 is configured to receive a second measurement result, where the second measurement result includes the TA values at the N moments.

In some embodiments, the second measurement result further includes at least one of: information of a satellite for each TA value recording, or a RSRP measurement result obtained based on SRS measurement.

In some embodiments, the information of the satellite for each TA value recording includes at least one of: location information of the satellite, ephemeris information of the satellite, identification information of the satellite, a feeder link delay, a common TA value, or a Kmac value.

In some embodiments, the second measurement result is transmitted by the access network device in response to a second condition being met, where the second condition includes at least one of: reaching a number of TA recording, reaching a TA recording duration, reaching a TA recording end moment, or reaching a TA reporting response moment.

In some embodiments, the second information further includes at least one of: the number of TA recording, the TA recording duration, the TA recording end moment, or the TA reporting response moment.

In some embodiments, the second measurement result is carried by a new radio positioning protocol a (NRPPa) message.

In some embodiments, the core network device 700 further includes a processing unit 730. The processing unit 730 is configured to determine location information of the terminal device according to the second measurement result.

In some embodiments, multiple measurement results are reported in same information, or a TA value of each measurement result among the multiple measurement results is reported separately, where the multiple measurement results include at least the second measurement result.

In some embodiments, the TA value is a TA value of a terminal device, or the TA value is a TA value of a service link.

In some embodiments, the TA value of the service link is determined based on the TA value of the terminal device, a common TA value, and a Kmac value.

In some embodiments, the N moments are moments with respect to a same satellite cell, or the N moments are moments with respect to multiple satellite cells.

In some embodiments, the second information is measurement request information.

In some embodiments, the second information is carried by an NRPPa message.

In some embodiments, the core network device is a location management function (LMF) entity, or the core network device is an access and mobility management function (AMF) entity.

In some embodiments, the communication unit may be a communication interface or a transceiver, or an input/output interface of a communication chip or a system-on-chip (SOC). The processing unit may be one or more processors.

It should be understood that, the core network device 700 according to embodiments of the disclosure may correspond to the core network device in the method embodiments of the disclosure, and the foregoing and other operations and/or functions of various units in the core network device 700 are respectively intended for implementing corresponding operations of the core network device in the method 300 illustrated in FIG. 7, which will not be described again herein for the sake of brevity.

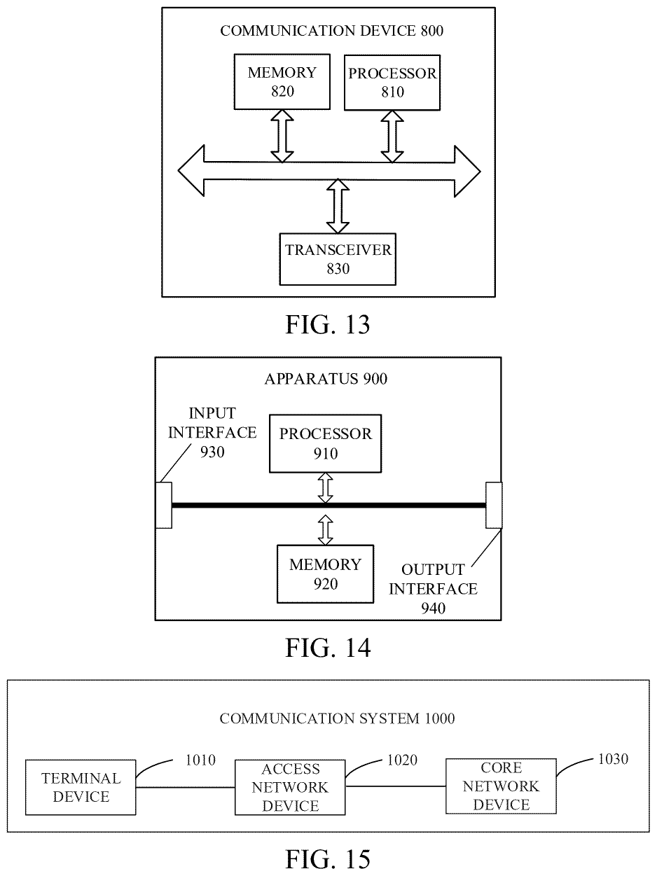

FIG. 13 is a schematic structural diagram of a communication device 800 provided in embodiments of the disclosure. As illustrated in FIG. 13, the communication device 800 includes a processor 810. The processor 810 can invoke and execute computer programs stored in a memory to perform the method provided in embodiments of the disclosure.

In some embodiments, as illustrated in FIG. 13, the communication device 800 can further include the memory 820. The processor 810 can invoke and execute the computer programs stored in the memory 820 to perform the method provided in embodiments of the disclosure.

The memory 820 may be a separate device independent of the processor 810, or may be integrated into the processor 810.

In some embodiments, as illustrated in FIG. 13, the communication device 800 can further include a transceiver 830. The processor 810 can control the transceiver 830 to communicate with other devices, for example, to transmit information or data to other devices, or to receive information or data from other devices.

The transceiver 830 may include a transmitter and a receiver. The transceiver 830 may further include an antenna, where one or more antenna can be provided.

In some embodiments, the processor 810 can implement the function of the processing unit in the terminal device, or the processor 810 can implement the function of the processing unit in the access network device, or the processor 810 can implement the function of the processing unit in the core network device, which will not be described again herein for the sake of brevity.

In some embodiments, the transceiver 830 can implement the function of the communication unit in the terminal device, which will not be described again herein for the sake of brevity.

In some embodiments, the transceiver 830 can implement the function of the communication unit in the access network device, or the transceiver 830 can implement the function of the communication unit in the core network device, which will not be described again herein for the sake of brevity.

In some embodiments, the communication device 800 may specifically be the access network device in embodiments of the disclosure, and the communication device 800 can implement the corresponding procedures performed by the access network device in methods in embodiments of the disclosure, which will not be described again herein for the sake of brevity.

In some embodiments, the communication device 800 may specifically be the core network device in embodiments of the disclosure, and the communication device 800 can implement the corresponding procedures performed by the core network device in methods in embodiments of the disclosure, which will not be described again herein for the sake of brevity.

In some embodiments, the communication device 800 may specifically be the terminal device in embodiments of the disclosure, and the communication device 800 can implement the corresponding procedures performed by the terminal device in methods in embodiments of the disclosure, which will not be described again herein for the sake of brevity.

FIG. 14 is a schematic structural diagram of an apparatus according to embodiments of the disclosure. As illustrated in FIG. 14, the apparatus 900 includes a processor 910. The processor 910 is configured to invoke and execute computer programs stored in a memory to perform the method provided in embodiments of the disclosure.

In some embodiments, as illustrated in FIG. 14, the apparatus 900 further includes the memory 920. The processor 910 can invoke and execute the computer programs stored in the memory 920 to perform the method provided in embodiments of the disclosure.

The memory 920 may be a separate device independent of the processor 910, or may be integrated into the processor 910.

In some embodiments, the apparatus 900 may further include an input interface 930. The processor 910 can control the input interface 930 to communicate with other devices or chips, for example, to acquire information or data transmitted by other devices or chips. Optionally, the processor 910 may be inside or outside the chip.

In some embodiments, the processor 910 can implement the function of the processing unit in the terminal device, or the processor 910 can implement the function of the processing unit in the access network device, or processor 910 can implement the function of the processing unit in the core network device, which will not be described again herein for the sake of brevity.

In some embodiments, the input interface 930 can implement the function of the communication unit in the terminal device, or the input interface 930 can implement the function of the communication unit in the access network device, or the input interface 930 can implement the function of the communication unit in the core network device.

In some embodiments, the apparatus 900 may further include an output interface 940. The processor 910 can control the output interface 940 to communicate with other devices or chips, for example, to output information or data to other devices or chips. Optionally, the processor 910 may be inside or outside the chip.

In some embodiments, the output interface 940 can implement the function of the communication unit in the terminal device, or the output interface 940 can implement the function of the communication unit in the access network device, or the output interface 940 can implement the function of the communication unit in the core network device.

In some embodiments, the apparatus is applicable to the access network device in embodiments of the disclosure, and the apparatus can implement the corresponding procedures performed by the access network device in methods in embodiments of the disclosure, which will not be repeated herein for the sake of simplicity.

In some embodiments, the apparatus is applicable to the core network device in embodiments of the disclosure, and the apparatus can implement the corresponding procedures performed by the core network device in methods in embodiments of the disclosure, which will not be repeated herein for the sake of simplicity.

In some embodiments, the apparatus is applicable to the terminal device in embodiments of the disclosure, and the apparatus can implement the corresponding procedures performed by the terminal device in methods in embodiments of the disclosure, which will not be repeated herein for the sake of simplicity.

In some embodiments, the apparatus mentioned in embodiments of the disclosure may also be a chip, for example, may be a system-level chip, a system chip, a chip system, or an on-chip system chip.

FIG. 15 is a schematic block diagram of a communication system 1000 provided in embodiments of the disclosure. As illustrated in FIG. 15, the communication system 1000 includes a terminal device 1010, an access network device 1020, and a core network device 1030.

The terminal device 1010 may be configured to implement the corresponding functions implemented by the terminal device in the above methods, the access network device 1020 may be configured to implement the corresponding functions implemented by the access network device in the above methods, and the core network device 1030 may be configured to implement the corresponding functions implemented by the core network device in the above methods, which will not be repeated herein for the sake of simplicity.

It should be understood that, the processor referred to herein may be an integrated circuit chip with signal processing capabilities. During implementation, each step of the foregoing method embodiments may be completed by an integrated logic circuit in the form of hardware or an instruction in the form of software in the processor. The processor may be a general-purpose processor, a digital signal processor (DSP), an application specific integrated circuit (ASIC), a field programmable gate array (FPGA), or other programmable logic devices, discrete gates or transistor logic devices, or discrete hardware components, which can implement or perform the methods, steps, and logic blocks disclosed in embodiments. The general purpose processor may be a microprocessor, or the processor may be any conventional processor or the like. The steps of the method disclosed in embodiments may be implemented through a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware of the processor.

It can be understood that, the memory according to embodiments of the disclosure may be a volatile memory or a non-volatile memory, or may include both the volatile memory and the non-volatile memory. The non-volatile memory may be a ROM, a PROM, an erasable programmable read only memory (erasable PROM, EPROM), an electrically erasable programmable read only memory (electrically EPROM, EEPROM), or a flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link dynamic random access memory (synch-link DRAM, SLDRAM), and a direct rambus RAM (DRRAM). It should be noted that, the memory of systems and methods described herein is intended to include, but is not limited to, these and any other suitable types of memories.

It should be understood that, the above description of the memory is intended for illustration rather than limitation. For example, the memory of embodiments may also be an SRAM, a DRAM, an SDRAM, a DDR SDRAM, an ESDRAM, an SLDRAM, a DR RAM, etc. In other words, the memory of embodiments is intended to include, but is not limited to, these and any other suitable types of memory.

Embodiments of the disclosure further provide a computer-readable storage medium. The computer-readable storage medium is configured to store computer programs.

In some embodiments, the computer-readable storage medium is applicable to the access network device of embodiments of the disclosure. The computer programs are operable with a computer to implement the corresponding procedures performed by the access network device in methods in embodiments of the disclosure, which will not be repeated herein for the sake of simplicity.

In some embodiments, the computer-readable storage medium is applicable to the core network device of embodiments of the disclosure. The computer programs are operable with a computer to implement the corresponding procedures performed by the core network device in methods in embodiments of the disclosure, which will not be repeated herein for the sake of simplicity.

In some embodiments, the computer-readable storage medium is applicable to the terminal device of embodiments of the disclosure. The computer programs are operable with a computer to implement the corresponding procedures performed by the terminal device in methods in embodiments of the disclosure, which will not be repeated herein for the sake of simplicity.

Embodiments of the disclosure further provide a computer program product. The computer program product includes computer program instructions.

In some embodiments, the computer program product is applicable to the access network device of embodiments of the disclosure. The computer program instructions are operable with a computer to implement the corresponding procedures by the access network device in methods in embodiments of the disclosure, which will not be repeated herein for the sake of simplicity.

In some embodiments, the computer program product is applicable to the core network device of embodiments of the disclosure. The computer program instructions are operable with a computer to implement the corresponding procedures performed by the core network device in methods in embodiments of the disclosure, which will not be repeated herein for the sake of simplicity.

In some embodiments, the computer program product is applicable to the terminal device of embodiments of the disclosure. The computer program instructions are operable with a computer to implement the corresponding procedures performed by the terminal device in methods in embodiments of the disclosure, which will not be repeated herein for the sake of simplicity.

Embodiments of the disclosure further provide a computer program.

In some embodiments, the computer program is applicable to the access network device of embodiments of the disclosure. The computer program, when executed by a computer, is operable with the computer to implement the corresponding procedures performed by the access network device in methods in embodiments of the disclosure, which will not be repeated herein for the sake of simplicity.

In some embodiments, the computer program is applicable to the core network device of embodiments of the disclosure. The computer program, when executed by a computer, is operable with the computer to implement the corresponding procedures performed by the core network device in methods in embodiments of the disclosure, which will not be repeated herein for the sake of simplicity.

In some embodiments, the computer program is applicable to the terminal device of embodiments of the disclosure. The computer program, when executed by a computer, is operable with the computer to implement the corresponding procedures performed by the terminal device in methods in embodiments of the disclosure, which will not be repeated herein for the sake of simplicity.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may also available in practice, e.g., multiple units or assemblies may be combined or may be integrated into another system, or some features may be ignored or omitted. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

In addition, various functional units described in embodiments of the disclosure may be integrated into one processing unit or may be present as a number of physically separated units, and two or more units may be integrated into one.

If the integrated units are implemented as software functional units and sold or used as standalone products, they may be stored in a computer-readable storage medium. For such an understanding, the essential technical solution, or the portion that contributes to the prior art, or part of the technical solution of the disclosure may be embodied as software products. The computer software products can be stored in a storage medium and may include multiple instructions that, when executed, can cause a computing device, e.g., a personal computer, a server, a network device, etc., to execute some or all operations of the methods described in various embodiments. The above storage medium may include various kinds of media that can store program codes, such as a universal serial bus (USB) flash disk, a mobile hard drive, a ROM, a RAM, a magnetic disk, or an optical disk.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A wireless communication method, comprising:
receiving, by a terminal device, first information, wherein the first information is used to configure or indicate the terminal device to report timing advance (TA) values at M moments, where M is a positive integer and M≥2.

2-5. (canceled)

6. The method of claim 1, further comprising:
transmitting, by the terminal device, a first measurement result, wherein the first measurement result comprises the TA values at the M moments.

7. The method of claim 6, wherein the first measurement result further comprises at least one of: time information for each TA value recording, information of a satellite for each TA value recording, or a reference signal received power (RSRP) measurement result for each TA value recording.

8-10. (canceled)

11. The method of claim 6, wherein the first measurement result is carried by a long term evolution positioning protocol (LPP) message.

12. (canceled)

13. The method of claim 1, wherein the TA value is a TA value of the terminal device, or the TA value is a TA value of a service link.

14. The method of claim 1, wherein the TA values at the M moments are reported in same information, or the TA value at each of the M moments is reported separately.

15. The method of claim 1, wherein the M moments are moments with respect to a same satellite cell, or the M moments are moments with respect to a plurality of satellite cells.

16. The method of claim 1, wherein the first information is location information request information.

17. The method of claim 1, wherein the first information is carried by an LPP message.

18. A wireless communication method, comprising:
transmitting, by a core network device, first information, wherein the first information is used to configure or indicate a terminal device to report timing advance (TA) values at M moments, where M is a positive integer and M≥2.

19-21. (canceled)

22. The method of claim 18, wherein TA values at adjacent moments among the M moments differ by one TA deviation threshold.

23. The method of any claim 18, further comprising:
receiving, by the core network device, a first measurement result, wherein the first measurement result comprises the TA values at the M moments.

24. The method of claim 23, wherein the first measurement result further comprises at least one of: time information for each TA value recording, information of a satellite for each TA value recording, or a reference signal received power (RSRP) measurement result for each TA value recording.

25-27. (canceled)

28. The method of claim 23, wherein the first measurement result is carried by a long term evolution positioning protocol (LPP) message.

29-30. (canceled)

31. The method of claim 18, wherein the TA value is a TA value of the terminal device, or the TA value is a TA value of a service link.

32. The method of claim 18, wherein the TA values at the M moments are reported in same information, or the TA value at each of the M moments is reported separately.

33. The method of claim 18, wherein the M moments are moments with respect to a same satellite cell, or the M moments are moments with respect to a plurality of satellite cells.

34. The method of claim 18, wherein the first information is location information request information.

35. The method of claim 18, wherein the first information is carried by an LPP message.

36-82. (canceled)

83. A terminal device, comprising:
a memory configured to store computer programs; and
a processor configured to invoke and execute the computer programs stored in the memory, to cause the terminal device to:
receive first information, wherein the first information is used to configure or indicate the terminal device to report timing advance (TA) values at M moments, where M is a positive integer and M≥2.

84-90. (canceled)
